(19) United States
(12) Patent Application Publication
(10) Pub. No.: US 2016/0121897 A1
(43) Pub. Date: May 5, 2016

(54) Vehicle and Method of Control Thereof

(71) Applicant: JAGUAR LAND ROVER LIMITED, Coventry, Warwickshire (GB)

(72) Inventor: Rob Jerger, Coventry (GB)

(21) Appl. No.: 14/897,029

(22) PCT Filed: Jul. 15, 2014
(86) PCT No.: PCT/EP2014/065164

§ 371 Date: Dec. 9, 2015

(30) Foreign Application Priority Data
Jul. 15, 2013 (GB) 1312588.5

(51) Int. Cl. B60W 30/18; B60W 10/10; B60W 10/06

(52) U.S. Cl. CPC B60W 30/18018; B60W 10/06; B60W 10/10; B60W 2540/12; B60W 2510/0604; B60W 2710/06; B60W 2710/10

(57) ABSTRACT

A controller for a motor vehicle, the vehicle comprising: drive means operable to provide motive power to the vehicle, the drive means being operable automatically to be switched off and subsequently restarted during a drive-cycle thereby to reduce an amount of time for which the drive means is on during a given drivecycle, and a transmission operable to be connected to and disconnected from the drive means, the controller comprising an input for receiving vehicle data; processing means arranged to determine control signals for controlling the transmission in dependence on the vehicle data received at the inputs; and an output arranged to output the determined control signals to the transmission, wherein the processing means is arranged to determine a drive means restart type, to determine the control signals for controlling the transmission in dependence on the drive means restart type and, in the event that the processing means determines that the restart type is a system requested restart, the processing means is arranged to maintain the transmission in a state of disconnection from the drive means.

### FIELD OF THE INVENTION

The present invention relates to a vehicle and to a method of controlling a vehicle. In particular, but not exclusively, the invention relates to a vehicle having stop/start functionality in which an actuator may be automatically stopped and restarted during the course of a drivecycle. By drivecycle is meant a period during which a vehicle is used to undertake a journey, commencing when the driver initiates starting of the vehicle (or ‘key on’) and ending when the driver initiates shutdown of the vehicle (or ‘key off’). Aspects of the invention relate to a controller, a method and a vehicle.

### BACKGROUND

It is known to provide a motor vehicle having stop/start functionality in which an engine of the vehicle is switched off to save fuel when conditions permit such as when the vehicle is held stationary with a driver-operated brake pedal depressed. The condition in which the vehicle is held stationary with the engine automatically switched off during a drivecycle is known as an ‘eco-stop’ condition.

When the driver releases the brake pedal the engine may be restarted and a transmission of the vehicle may be re-engaged. That is, under ‘no fault’ normal operating conditions, release of the brake pedal by the driver triggers the engine to be restarted, the driveline to be closed and torque to be transmitted to the drive wheels.

It is noted that as well as a driver action the engine of the vehicle may be restarted if power is required for a heater-ventilation system or for battery maintenance reasons.

It is therefore an object of the present invention to provide an improved controller for controlling a vehicle during an eco-start condition.

### STATEMENT OF THE INVENTION

In one aspect for which protection is sought, the present invention provides a controller for a motor vehicle, the vehicle comprising: drive means operable to provide motive power to the vehicle, the drive means being operable automatically to be switched off and subsequently restarted during a drivecycle thereby to reduce an amount of time for which the drive means is on during a given drivecycle, and a transmission operable to be connected to and disconnected from the drive means, the controller comprising:
an input for receiving vehicle data;
processing means arranged to determine control signals for controlling the transmission in dependence on the vehicle data received at the inputs; and
an output arranged to output the determined control signals to the transmission,
wherein the processing means is arranged to determine a drive means restart type, to determine the control signals for controlling the transmission in dependence on the drive means restart type and, in the event that the processing means determines that the restart type is a system requested restart, the processing means is arranged to maintain the transmission in a state of disconnection from the drive means.

In this manner, if a restart has occurred due to a vehicle system request then the controller may elect not to connect the transmission to the drive means, thereby reducing CO2 emission and improving fuel economy.

The processing means may arranged to determine a drive means restart type when the drive means is restarted.

The processing means may be arranged, when the drive means is restarted, to determine if the restart is a driver requested restart or a system requested restart.

The processing means may be arranged to determine if the restart is a driver requested restart by analysing the received vehicle data for data originating from one or more of the following: parking brake sub-system, brake pedal sub-system, accelerator sub-system.

The processing means may be arranged to determine if the restart is a system requested restart by analysing the received vehicle data for data originating from one or more of the following: air conditioning sub-system, heater-ventilation sub-system, battery charging sub-system.

In the event that the processing means determines that the restart type is a driver requested restart, the processing means may be arranged to determine a control signal to connect the transmission to the drive means.

The processing means may be arranged to determine the drive means restart type as the drive means is restarted from an eco-stop condition.

The processing means may be arranged to determine the drive means restart type as the drive means is restarted with a driver operable actuator for the transmission located in a drive position.

The processing means may be arranged to maintain the transmission in a state of disconnection from the drive means until at least one of the following conditions is determined:
a throttle demand;
a brake pedal is not depressed; and
brake pedal pressure is not sufficient to hold the vehicle stationary.

In another aspect, the present invention provides an engine controller for a vehicle comprising a controller according to the preceding aspect.

In a further aspect, the present invention provides a transmission controller for a vehicle comprising a controller according to the preceding aspect.

In yet another aspect, the present invention provides a vehicle comprising a controller according to the preceding aspect, the vehicle comprising drive means operable to provide motive power to the vehicle, the drive means being operable automatically to be switched off and subsequently restarted during a drivecycle thereby to reduce an amount of time for which the drive means is on during a given drivecycle, and a transmission operable to be connected to and disconnected from the drive means.

In a further aspect, the present invention provides a method of controlling a motor vehicle, the vehicle comprising: drive means operable to provide motive power to the vehicle, the drive means being operable automatically to be switched off and subsequently restarted during a drivecycle thereby to reduce an amount of time for which the drive means is on during a given drivecycle, and a transmission operable to be connected to and disconnected from the drive means, the method comprising:
receiving vehicle data;
determining control signals for controlling the transmission in dependence on the received vehicle data;
outputting the determined control signals to the transmission;
   wherein the method comprises:
determining a drive means restart type;
determining the control signals for controlling the transmission dependent on the drive means restart type; and
in the event that the determined restart type is a system requested restart, maintaining the transmission in a state of disconnection from the drive means.

The method may comprise determining the drive means restart type when the drive means is restarted.

The method may comprise, when the drive means is restarted, determining if the restart is a driver requested restart or a system requested restart.

The method may comprise determining if the restart is a driver requested restart by analysing the received vehicle data for data originating from one or more of the following: parking brake sub-system, brake pedal sub-system, accelerator sub-system.

The method may comprise determining if the restart is a system requested restart by analysing the received vehicle data for data originating from one or more of the following: air conditioning sub-system, heater-ventilation sub-system, battery charging sub-system.

The method may comprise, in the event that it is determined that the restart type is a driver requested restart, outputting a control signal to connect the transmission to the drive means.

The method may comprise determining the drive means restart type as the drive means is restarted from an eco-stop condition.

The method may comprise determining the drive means restart type as the drive means is restarted with a driver operable actuator for the transmission located in a drive position.

The method may comprise maintaining the transmission in a state of disconnection from the drive means until at least one of the following conditions is determined:
a throttle demand;
a brake pedal is not depressed; and
brake pedal pressure is not sufficient to hold the vehicle stationary.

In a further aspect, the present invention provides a controller for a motor vehicle, the vehicle comprising: drive means operable to provide motive power to the vehicle, the drive means being operable automatically to be switched off and subsequently restarted during a drivecycle thereby to reduce an amount of time for which the drive means is on during a given drivecycle, and a transmission operable to be connected to and disconnected from the drive means, the controller being configured to determine a drive means restart type and, in the event that the processing means determines that the restart type is a system requested restart, to maintain the transmission in a state of disconnection from the drive means.

In this manner, if a restart has occurred due to a vehicle system request then the controller may elect not to connect the transmission to the drive means, thereby reducing CO2 emission and improving fuel economy.

In a further aspect, the present invention provides a method of controlling a motor vehicle, the vehicle comprising: drive means operable to provide motive power to the vehicle, the drive means being operable automatically to be switched off and subsequently restarted during a drivecycle thereby to reduce an amount of time for which the drive means is on during a given drivecycle, and a transmission operable to be connected to and disconnected from the drive means, the method comprising:
determining a drive means restart type; and
in the event that the determined restart type is a system requested restart, maintaining the transmission in a state of disconnection from the drive means.

In an aspect of the invention there is provided a controller for a motor vehicle, the vehicle comprising: drive means operable to provide motive power to the vehicle, the drive means being operable automatically to be switched off and subsequently restarted during a drivecycle thereby to reduce an amount of time for which the drive means is on during a given drivecycle and a transmission operable to be connected to and disconnected from the drive means, the controller comprising: an input for receiving vehicle data; a processor arranged to determine control signals for controlling the transmission in dependence on the vehicle data received at the inputs; an output arranged to output the determined control signals to the transmission wherein the processor is arranged, to determine a drive means restart type and to determine the control signals for controlling the transmission in dependence on the drive means restart type.

In an embodiment there is provided a controller for controlling the transmission of a vehicle such that the transmission is controlled in dependence upon the type of drive means restart that has occurred when the drive means restarts. The controller recognises that drive means restarts may be system initiated (e.g. via an air conditioning system requiring power or via a battery charging system) or may be driver initiated (e.g. the driver may release a brake pedal and/or depress an accelerator pedal). The controller receives vehicle data that allows the processor to determine the type of drive means restart and to output a control signal to the transmission in dependence upon the restart type. Conveniently, the processor may be arranged to determine a drive means restart type when the drive means is restarted.

In this manner, if a restart has occurred due to a vehicle system request then the controller may elect not to connect the transmission to the drive means, thereby reducing CO2 emission and improving fuel economy.

In an embodiment, the processor may be arranged, when the drive means is restarted, to determine if the restart is a driver requested restart or a system requested restart.

Conveniently, the processor may be arranged, when the drive means is restarted, to determine if the restart is a driver requested restart by analysing the received vehicle data for data originating from one or more of the following: parking brake sub-system, brake pedal sub-system, accelerator sub-system.

Conveniently, the processor may be arranged, when the drive means is restarted, to determine if the restart is a system requested restart by analysing the received vehicle data for data originating from one or more of the following: air conditioning sub-system, heater-ventilation sub-system, battery charging sub-system.

In the event that the processor determines that the restart type is a driver requested restart, the processor may be arranged to determine a control signal to connect the transmission to the drive means.

Alternatively, in the event that the processor determines that the restart type is a system requested restart, the processor may be arranged to maintain the transmission in a state of disconnection from the drive means.

The processor may be arranged to determine the drive means restart type as the drive means is restarted from an eco-stop condition. The processor may be arranged to determine the drive means restart type as the drive means is restarted with a driver operable actuator for the transmission located in a drive position.

Embodiments of the present invention extend to an engine controller for a vehicle comprising a controller according to the first aspect of the invention and to a transmission controller for a vehicle comprising a controller according to the first aspect of the invention.

According to an aspect of the present invention there is provided a method of controlling a motor vehicle, the vehicle comprising: drive means operable to provide motive power to the vehicle, the drive means being operable automatically to be switched off and subsequently restarted during a drivecycle thereby to reduce an amount of time for which the drive means is on during a given drivecycle and a transmission operable to be connected to and disconnected from the drive means, the method comprising: receiving vehicle data; determining control signals for controlling the transmission in dependence on the received vehicle data; outputting the determined control signals to the transmission wherein, when the drive means is restarted, determining a drive means restart type and determining the control signals for controlling the transmission in dependence on the drive means restart type.

Embodiments of the invention have the advantage that if the driver forgets that the vehicle is in the eco-stop condition when the vehicle is stationary, the drive means will not re-start when the driver releases the driver-operated brake means. Thus, a risk that the vehicle begins to move unexpectedly is reduced.

It is to be understood for the present purposes that the term ‘eco-stop’ includes the condition in which the drive means of a hybrid electric vehicle is turned off when stationary, the drive means comprising an engine and one or more electric machines, as well as the condition in which the drive means of a stop/start vehicle (which may consist of an engine only) is turned off when stationary.

The drive means may comprise an electric machine, wherein in the first mode the vehicle may be held in the eco-stop condition by the driver-operated brake means in which the vehicle is stationary and the electric machine is off, the vehicle being operable automatically to restart the electric machine when the driver signals release of the brake means.

In an embodiment the drive means comprises an engine, wherein in the first mode the vehicle may be held in the eco-stop condition by the driver-operated brake means in which the vehicle is stationary and the engine is off, the vehicle being operable automatically to restart the engine when the driver signals release of the brake means.

Optionally the vehicle is a hybrid electric vehicle (HEV) wherein the drive means comprises an engine and at least one electric machine.

The vehicle may be operable in a parallel HEV mode in which the engine and at least one electric machine provide motive torque to drive the vehicle in parallel.

Alternatively or in addition the HEV may be operable in a series mode in which the engine is arranged to generate electric power to drive at least one electric machine thereby to provide motive torque to drive the vehicle.

In an aspect of the invention there is provided a method of controlling a motor vehicle, the vehicle comprising: drive means operable to provide motive power to the vehicle, the drive means being operable automatically to be switched off and subsequently restarted during a drivecycle thereby to reduce an amount of time for which the drive means is on during a given drivecycle and a transmission operable to be connected to and disconnected from the drive means, the method comprising: receiving vehicle data; determining control signals for controlling the transmission in dependence on the received vehicle data; outputting the determined control signals to the transmission wherein, determining a drive means restart type and/or determining the control signals for controlling the transmission is in dependence on the drive means restart type.

Within the scope of this application it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment or aspect are applicable to all embodiments, unless such features are incompatible.

### BRIEF DESCRIPTION OF THE DRAWINGS

Embodiments of the invention will now be described with reference to the accompanying figures in which:

FIG. 1 is a schematic illustration of a stop/start motor vehicle according to an embodiment of the present invention;

FIG. 2 is a flow chart relating to a known stop/start vehicle showing a sequence leading to the vehicle's engine switching off;

FIG. 3 is a flow chart relating to a known stop/start vehicle showing a sequence leading to the vehicle's engine restarting; and

FIG. 4 is a flow chart of a stop/start strategy according to an embodiment of the present invention.

### DETAILED DESCRIPTION

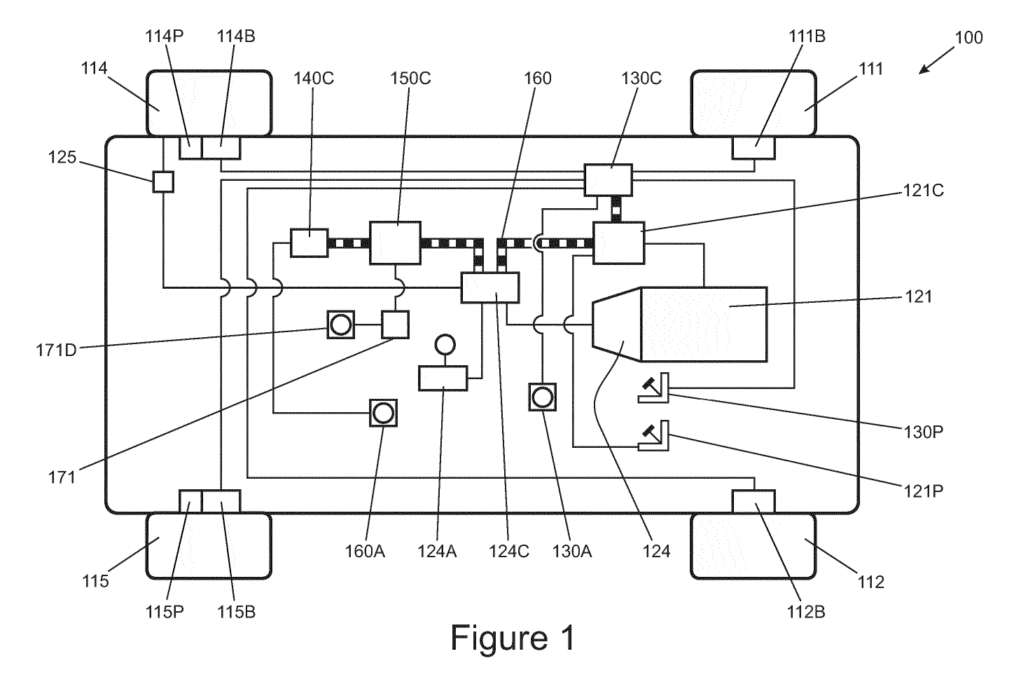

FIG. 1 shows a typical configuration for a stop/start vehicle 100. As shown in FIG. 1 the vehicle 100 comprises an internal combustion engine 121, an automatic transmission 124 and a set of four wheels 111, 112, 114, 115. Each of the wheels has a respective disc brake 111B, 112B, 114B, 115B operable by means of a driver operated brake pedal 130P to decelerate the vehicle when the vehicle is moving. Rear wheels 114, 115 of the vehicle are also provided with a respective driver operated parking brake 114P, 115P each in the form of a drum brake. The parking brakes 114P, 115P are operable to be applied and released by means of a driver-operated parking brake actuator 130A in the form of a push-button actuator. A driver operated accelerator pedal 121P allows the engine 121 to be operated to accelerated the vehicle when the vehicle is moving.

The vehicle 100 has a body controller (BCM) 140C, an engine controller 121C, a brake controller 130C, a transmission controller 124C and a restraint controller 150C. The controllers 140C, 121C, 130C, 124C, 150C are arranged to communicate with one another by means of a controller area network (CAN) bus 160.

The body controller 140C is arranged to detect the status of a driver's door of the vehicle by means of a door sensor 160A and the state of a bonnet (or hood) of the vehicle 100.

The engine 121 is operable to be started and stopped by means of the engine controller 121C. The engine controller 121C is arranged to implement a stop/start scheduler that determines when the engine 121 should be stopped according to a stop/start control methodology. When it is determined that the engine should be stopped the stop/start scheduler commands the engine controller 121C to stop the engine 121. When it is determined that the engine 121 should be restarted, the stop/start scheduler commands the engine controller 121C to restart the engine 121.

The engine controller 121C is arranged to receive an input from the brake controller 130C. When the engine has been stopped according to a command by the stop/start scheduler, the brake controller 130C is arranged to trigger the stop/start scheduler to restart the engine 121 when the brake pedal 130P is released.

The brake controller 130C is operable to apply the parking brakes or disc brakes according to signals received from the brake pedal 130P and parking brake actuator 130A, respectively.

The transmission controller 124C is operable to control the transmission 124 in order to connect and disconnect the transmission 124 from the engine 121. The controller 124C is also operable to control the transmission 124 to operate according to one of a plurality of modes of operation. A driver operable actuator 124A is coupled to the transmission controller 124C by means of which the driver may select the required mode.

In the vehicle of FIG. 1 the modes are: (1) a park mode in which the transmission 124 is disconnected from the engine 121 and a park mode pin element 125 is controlled to immobilise a rear wheel 114 of the vehicle; (2) a reverse mode in which the transmission 124 is arranged to drive the vehicle in a reverse direction; (3) a neutral mode in which the transmission 124 is disengaged from the engine but the park mode pin element 125 is not engaged; (4) a drive mode in which the transmission 124 is engaged with the engine 121 and is operable automatically to select a required one of eight forward gears of the transmission 124; and (5) a low gear mode in which the transmission 124 is operable automatically to select a first or second gear only.

It is to be understood that other numbers of gears are also useful such as five, six, nine or any other suitable number of gears.

It is to be understood that the transmission controller 124C may control the transmission 124 to assume the park mode when required.

It is to be understood that in some vehicle configurations, when the transmission controller 124C controls the transmission 124 to assume the park mode the vehicle 100 is controlled such that a driver-operable transmission mode selector assumes the park mode in addition to the transmission 124 itself assuming the park mode.

In some configurations the transmission mode selector is required to be physically moved in order to assume the park mode. In some alternative embodiments the transmission mode selector is not required to physically move. For example the mode selector may be provided in the form of a ‘soft key’ or a ‘soft rotary control’ or ‘dial’. Since the physical position or state of the selector is not indicative of the selected mode an electronically-controlled indication of the selected mode is provided whereby the selected mode may be determined by the driver.

The vehicle 100 is also operable to assume a stop/start mode according to the state of a driver-operated actuator 124A. In the stop/start mode the stop/start scheduler is arranged to command the engine 121 to stop under selected conditions in which a fuel saving may be made. The conditions may be selected to be conditions in which the engine 121 may be stopped without unduly compromising performance of the vehicle. In some embodiments the engine 121 is stopped under selected conditions in which an amount of carbon dioxide and/or other undesirable gas emitted by the engine 121 may be reduced.

For example, if the driver holds the vehicle 100 in a stationary condition by means of the brake pedal 130P (which applies the disc brakes 111B, 112B, 114B and 115B as described above), in the stop/start mode the vehicle 100 is arranged to command the stop/start scheduler to switch off the engine 121 thereby to save fuel as described above. This state will be referred to as an ‘eco-stop condition’. That is, the vehicle 100 is stationary with the engine 121 stopped automatically according to the stop/start control methodology.

When the driver releases the brake pedal 130P the disc brakes 111B-115B continue to be applied automatically by the vehicle 100 and the engine 121 is restarted. Once the engine 121 has restarted the transmission 124 is connected to the engine 121 to provide torque to the wheels and the disc brakes 111B-115B are released.

In the vehicle 100 of FIG. 1 the restraint controller 150C is configured to detect whether or not the drivers seat belt buckle is fastened to a locking device 171D that secures the seat belt buckle thereby to restrain movement of the driver in the event of an impact. Accordingly the controller 150C is also coupled to a seat buckle state detector 171.

The seat belt buckle state detector 171 is configured to provide a signal to the restraint controller 150C responsive to whether or not the seat belt buckle is fastened to the locking device.

The vehicle 100 is configured to communicate an output of the seat belt buckle state detector 171 to the stop/start scheduler of the engine controller 121 in order to prevent restarting of the engine 121 if the brake pedal 130P is released when the seat belt buckle is unfastened (or ‘released’) from the locking device.

In the event that the vehicle 100 is in the eco-stop mode and the seat belt buckle state detector 171 indicates the seat belt buckle is unfastened (or ‘released’) the transmission 124 is controlled to assume the park mode and the vehicle 100 is controlled to assume the shutdown mode.

In the shutdown mode the eco-stop condition is exited so that there is no possibility that the engine will restart without an express command from the driver.

In some alternative configurations, in the event that the vehicle 100 is in the eco-stop mode and the vehicle 100 determines that the seat belt buckle is unfastened the vehicle determines that the driver is departing the vehicle as soon as the driver releases the brake pedal 130P. Thus the transmission 124 is controlled to assume the park mode and the vehicle 100 is controlled to assume the shutdown mode when the brake pedal 130P is released.

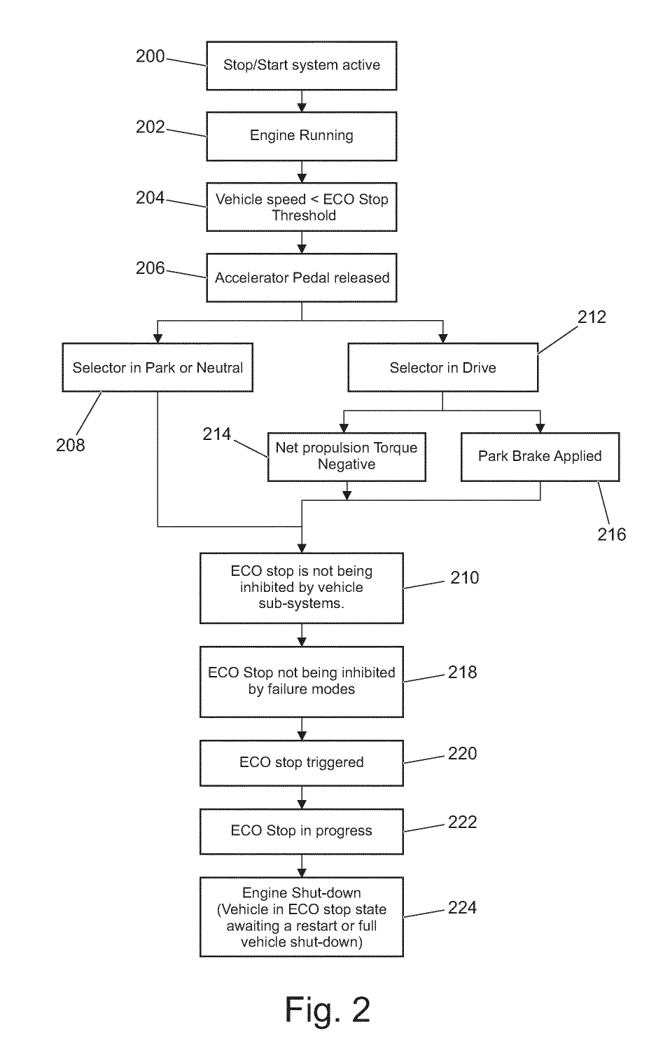

Turning to FIG. 2 a flow chart relating to a known stop/start vehicle showing a sequence of events leading to the vehicle's engine 121 switching off is shown.

In Step 200 the control system controlling the stop/start strategy is activated. The strategy may conveniently be controlled by the engine controller 121C shown in FIG. 1 and may be activated as soon as power is supplied to the controller, e.g. on insertion of drive key into ignition and supply of power from the vehicle battery.

In Step 202 the vehicle engine (drive means) is running and the engine controller 121C monitors for events that conform to the stop/start strategy.

In Step 204 the vehicle speed drops below an eco-stop threshold speed. The engine controller 121C may at this point start monitoring for other associated events that would indicate that the vehicle has entered an eco-stop condition.

In Step 206 the driver releases the accelerator pedal.

The vehicle may proceed towards an eco-stop condition via a few different routes at this point. At step 208 the transmission mode selector (driver operable actuator 124A) may be moved to either a “park” or “neutral” mode. If this occurs then the engine controller 121 C can proceed to step 210 in which it checks if the vehicle can proceed towards entering an eco-stop condition or if such a condition is currently being inhibited by one of the vehicle sub-systems (e.g. the battery level may be too low to enter such a condition or the air conditioning may be active. In either case the engine controller 121C would maintain the operation of the drive means rather than entering an eco-stop condition).

As an alternative to step 208 however the transmission mode selector (driver operable actuator 124A) may, in step 212 be moved into the “drive” position. If either the foot brake is engaged (step 214) or parking brake applied (step 216), then the engine controller 121C may then move to step 210 (as described above).

If the engine controller 121C determines that there are no vehicle sub-systems inhibiting an eco-stop then it checks, in step 218, whether an eco-stop condition is being inhibited by a vehicle failure mode, for example does the terrain response system on the vehicle indicate that the vehicle is on a steep slope?

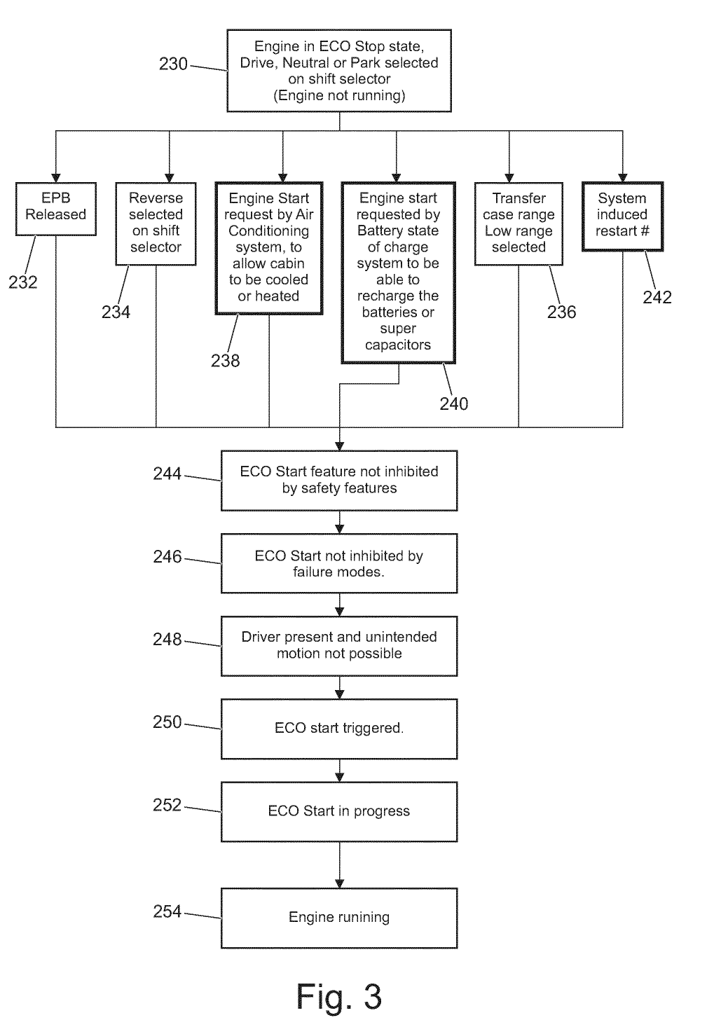

If no failure modes have been detected in step 218, then, in step 220, the engine controller 121C may trigger an eco-stop process. In step 222 the vehicle systems transition into a state appropriate for an eco-stop and in step 224 the drive means of the vehicle shuts down. The vehicle is now in an eco-stop state awaiting either a restart (see FIG. 3) or a full vehicle shut-down.

Turning to FIG. 3 a flow chart relating to a known stop/start vehicle showing a sequence of events leading to the vehicle's engine restarting is shown.

The drive means of the vehicle begins FIG. 3 in an eco-stop state (230). The transmission mode selector (driver operable actuator 124A) may be in “drive”, “neutral” or “park” and the drive means 121 is not running.

Restart of the drive means 121 may be caused by a number of events (232, 234, 236, 238, 240, 242).

In event 232 an electronic parking brake (114P, 115P in FIG. 1) may be released. In event 234, the transmission mode selector (actuator 124A) may be moved to select “reverse”. In event 236 a low gear mode may be selected.

It is noted that events 232, 234 and 236 all relate to the same drive means restart type, namely that they are driver induced/requested restarts.

In event 238 the vehicle air conditioning unit has caused the engine to restart in response to the vehicle cabin temperature rising too high or falling too low (this system requested restart relates to the Heater/Ventilation System, HEVAC, attempting to either heat or cool the vehicle cabin to a driver selected temperature). In event 240 the battery charge state has caused the engine to restart in order that the charge system can recharge the batteries or super capacitors.

It is noted that events 238 and 240 both relate to the same drive means restart type, namely that they are system induced restarts. Event 242 represents a further generic system induced restart. Further examples of system induced/requested restarts include a restart by the EPAS (Electrical Power Steering system) to aid the driver to turn the steering wheel, a restart by the EMS (engine management system) to keep the catalytic converters “lit off” amongst others.

In step 244, the engine controller 121C checks that an eco-start is not currently being inhibited by a vehicle safety feature (this step is a mirror of step 210 in FIG. 2).

In step 246, the engine controller 121C checks whether an eco-start is being inhibited by a vehicle safety mode (this step is a mirror of step 218 in FIG. 2).

In step 248, the engine controller 121C may check if there is a driver present and that unintended vehicle motion is not possible. It is noted that when the vehicle parks it will enter an eco-stop condition. If, for example, the driver's seatbelt has been disengaged then this would indicate that the driver is not present and that an eco-start should not be initiated.

If the driver has been determined as present in step 248 then in step 250 an eco-start may be triggered. In step 252 the vehicle sub-systems transition into a state appropriate for an eco-start and in step 254 the drive means (engine 121) is restarted and is running again.

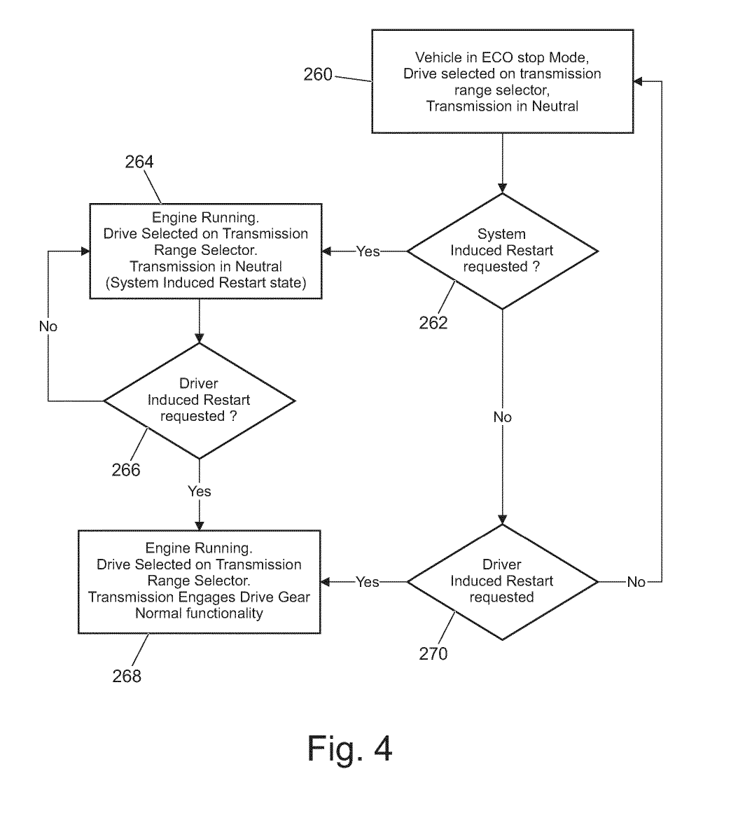

FIG. 4 is a flow chart of a control method in accordance with an embodiment of the present invention.

It is noted in the description below that the engine controller 121C is used to determine whether to engage the transmission 124 with the engine 121. However, it should be appreciated that the transmission controller 160 may alternatively perform this function and the description below should be read accordingly.

At step 260 the vehicle is in an eco-stop condition. The transmission mode selector (actuator 124A) is in “drive” but the transmission 124 has been disconnected from the engine 121 as part of the eco-stop process.

Once the engine 121 has been placed into the eco-stop mode of step 260, the engine controller 121C periodically checks whether a restart as a result of a driver command (i.e. drive means restart type is a driver induced/requested restart) or a system request (i.e. drive means restart type=system induced/requested restart) has occurred.

The engine controller 121C may determine the drive means restart type by receiving vehicle data from various vehicle sub systems. For example, the engine controller 121C may receive signals from the driver operated brake pedal 130P via the brake controller 130C. The engine controller may also receive signals from the driver operated accelerator pedal 121P. The parking brakes 114P, 115P are operable to be applied and released by means of a driver-operated parking brake actuator 130A and the engine controller 121C may also receive data signals from the parking brakes/parking brake actuator.

Additionally, the engine controller 121C may receive vehicle signals from other vehicle sub-systems such as the air conditioning system or from the battery charging system.

The engine controller 121C may therefore check, in step 262, whether a system restart has been requested by analysing the signal data received from the various vehicle sub-systems.

If the engine controller 121C determines that the restart type is a system restart (e.g. because it has received data from the air conditioning system but there has been no signal from any of the driver operated systems), then the engine controller 121C may move to step 264 in which the engine 121 is running but the transmission 124 has not been connected to the drive means 121.

Periodically, in step 266, the engine controller 121C checks to see if a driver induced restart has been requested (e.g. have any signals been received from a driver operated sub-system?). If no such signals have been received then the engine controller 121C loops back round to step 264. If a driver related signal has been received then the engine controller 121C updates the restart type to driver induced and the transmission 124 is connected to the engine 121C (step 268).

Alternatively, in step 262, if the engine controller 121C determines that a system restart has not been requested then the engine controller 121C may move to step 270 in which it checks whether a drive induced restart has been requested.

If the engine controller 121C determines that a driver induced restart has been requested (because, for example, a driver operated sub-system has signalled the engine controller 121C), then the engine controller 121C can again move straight to step 268.

However, if the engine controller 121C determines that a driver induced restart has not been requested then it may loop back round to step 260 and the cycle can repeat until either a driver restart is detected and the transmission is connected to the engine 121 or the engine 121 is switched off because the driver has parked/exited the vehicle. It is therefore noted that although not shown in FIG. 4 the engine controller 121C will also periodically check that the engine ignition has not been switched off.

In current vehicles, if the transmission mode selector (driver operable actuator 124A) is in Drive when the engine 121 enters an eco-stop, then on engine restart it currently reselects the drive gear engaging at least one clutch and all slip being taken up through the torque converter. This creates drag within the engine system and increases the CO₂ emissions of the engine. It also has a knock-on negative effect on fuel consumption.

A vehicle operating according to an embodiment of the present invention however only re-connects the transmission 124 to the engine 121 if the driver has requested the restart. If, however, the engine has restarted because it is a system induced restart then the transmission stays in Neutral. The transmission should only engage drive when the driver wants to launch the car, this saves the most fuel and has the best CO₂ emissions.

It is to be understood that embodiments of the present invention as described herein are also useful in hybrid electric vehicle (HEV) applications in which actuators of the vehicle are stopped when the vehicle is stationary in order to reduce fuel consumption and/or an amount of one or more gases emitted by the engine. The actuators are typically an engine and at least one electric machine operable as an electric motor.

It is to be understood that embodiments of the invention are suitable for use with a wide variety of vehicle types and modes of operation including series-type HEV vehicles.

Other arrangements are also useful.

The present invention extends to the following aspects as detailed in the following numbered paragraphs

1). A controller for a motor vehicle, the vehicle comprising: drive means operable to provide motive power to the vehicle, the drive means being operable automatically to be switched off and subsequently restarted during a drivecycle thereby to reduce an amount of time for which the drive means is on during a given drivecycle and a transmission operable to be connected to and disconnected from the drive means, the controller comprising: an input for receiving vehicle data; a processor arranged to determine control signals for controlling the transmission in dependence on the vehicle data received at the inputs; an output arranged to output the determined control signals to the transmission wherein the processor is arranged to determine a drive means restart type and to determine the control signals for controlling the transmission in dependence on the drive means restart type.

2). A controller as claimed in paragraph (1), wherein the processor is arranged to determine a drive means restart type when the drive means is restarted.

3). A controller as claimed in paragraph (2), wherein the processor is arranged, when the drive means is restarted, to determine if the restart is a driver requested restart or a system requested restart.

4). A controller as claimed in any paragraph (1), wherein the processor is arranged, to determine if the restart is a driver requested restart by analysing the received vehicle data for data originating from one or more of the following: parking brake sub-system, brake pedal sub-system, accelerator sub-system.

5). A controller as claimed in paragraph (1), wherein the processor is arranged, to determine if the restart is a system requested restart by analysing the received vehicle data for data originating from one or more of the following: air conditioning sub-system, heater-ventilation sub-system, battery charging sub-system.

6). A controller as claimed in paragraph (1), wherein, in the event that the processor determines that the restart type is a driver requested restart, the processor is arranged to determine a control signal to connect the transmission to the drive means.

7). A controller as claimed in paragraph (1), wherein, in the event that the processor determines that the restart type is a system requested restart, the processor is arranged to maintain the transmission in a state of disconnection from the drive means.

8). A controller as claimed in paragraph (1), wherein the processor is arranged to determine the drive means restart type as the drive means is restarted from an eco-stop condition.

9). A controller as claimed in paragraph (1), wherein the processor is arranged to determine the drive means restart type as the drive means is restarted with a driver operable actuator for the transmission located in a drive position.

10). An engine controller for a vehicle comprising a controller according paragraph (1).

11). A transmission controller for a vehicle comprising a controller according to paragraph (1).

12). A method of controlling a motor vehicle, the vehicle comprising: drive means operable to provide motive power to the vehicle, the drive means being operable automatically to be switched off and subsequently restarted during a drivecycle thereby to reduce an amount of time for which the drive means is on during a given drivecycle and a transmission operable to be connected to and disconnected from the drive means, the method comprising: receiving vehicle data; determining control signals for controlling the transmission in dependence on the received vehicle data and; outputting the determined control signals to the transmission, wherein determination of a drive means restart type and determination of the control signals for controlling the transmission is dependent on the drive means restart type.

1. A controller for a vehicle, wherein the vehicle comprises an engine operable to provide motive power to the vehicle, the engine being operable automatically to be switched off and subsequently restarted during a drivecycle thereby to reduce an amount of time for which the engine is on during a given drivecycle, and a transmission operable to be connected to and disconnected from the engine, wherein the controller comprises:
an input for receiving vehicle data;
a processor arranged to determine control signals for controlling the transmission in dependence on the vehicle data received at the input; and
an output arranged to output the control signals to the transmission,
wherein the processor is arranged to determine an engine restart type, to determine the control signals for controlling the transmission in dependence on the engine restart type and, in the event that the processor determines that the restart type is a system requested restart, the processor is arranged to maintain the transmission in a state of disconnection from the engine.

2. The controller of claim 1, wherein the processor is arranged to determine an engine restart type when the engine is restarted.

3. The controller of claim 2, wherein the processor is arranged, when the engine is restarted, to determine if the restart is a driver requested restart or a system requested restart.

4. The controller of claim 1, wherein the processor is arranged to determine if the restart type is a driver requested restart by analysing the received vehicle data for data originating from one or more of the following: parking brake sub-system, brake pedal sub-system, accelerator sub-system, and/or
wherein the processor is arranged to determine if the restart type is a system requested restart by analysing the received vehicle data for data originating from one or more of the following: air conditioning sub-system, heater-ventilation sub-system, battery charging sub-system.

5. (canceled)

6. The controller of claim 1, wherein, in the event that the processor determines that the restart type is a driver requested restart, the processor is arranged to determine a control signal to connect the transmission to the engine.

7. The controller of claim 1, wherein the processor is arranged to determine the engine restart type as the engine is restarted from an eco-stop condition.

8. The controller of claim 1, wherein the processor is arranged to determine the engine restart type as the engine is restarted with a driver operable actuator for the transmission located in a drive position.

9. The controller of claim 1, wherein the processor is arranged to maintain the transmission in a state of disconnection from the engine when the processor determines the restart type is a system requested restart until at least one of the following conditions is determined:
a throttle demand;
a brake pedal is not depressed; and
brake pedal pressure is not sufficient to hold the vehicle stationary.

10. An engine controller for a vehicle comprising a controller according to claim 1.

11. A transmission controller for a vehicle comprising a controller according to claim 1.

12. A vehicle comprising a controller according to claim 1, the vehicle comprising an engine operable to provide motive power to the vehicle, the engine being operable automatically to be switched off and subsequently restarted during a drivecycle thereby to reduce an amount of time for which the engine is on during a given drivecycle, and a transmission operable to be connected to and disconnected from the engine.

13. A method of controlling a vehicle, wherein the vehicle comprises an engine operable to provide motive power to the vehicle, the engine being operable automatically to be switched off and subsequently restarted during a drivecycle thereby to reduce an amount of time for which the engine is on during a given drivecycle, and a transmission operable to be connected to and disconnected from the engine, wherein the method comprises:
receiving vehicle data;
determining control signals for controlling the transmission in dependence on the received vehicle data;
outputting the determined control signals to the transmission;
determining an engine restart type;
determining control signals for controlling the transmission dependent on the engine restart type; and
in the event that the determined restart type is a system requested restart, maintaining the transmission in a state of disconnection from the engine.

14. The method of claim 13, comprising determining the engine restart type when the engine is restarted.

15. The method of claim 14, comprising, when the engine is restarted, determining if the restart is a driver requested restart or a system requested restart.

16. The method of claim 13, comprising determining if the restart is a driver requested restart by analysing the received vehicle data for data originating from one or more of the following: parking brake sub-system, brake pedal sub-system, accelerator sub-system.

17. The method of claim 13, comprising determining if the restart is a system requested restart by analysing the received vehicle data for data originating from one or more of the following: air conditioning sub-system, heater-ventilation sub-system, battery charging sub-system.

18. The method of claim 13, comprising, in the event that it is determined that the restart type is a driver requested restart, outputting a control signal to connect the transmission to the engine.

19. The method of claim 13, comprising determining the engine restart type as the engine is restarted from an eco-stop condition.

20. The method of claim 13, comprising determining the engine restart type as the engine is restarted with a driver operable actuator for the transmission located in a drive position.

21. The method of claim 13, comprising maintaining the transmission in a state of disconnection from the engine until at least one of the following conditions is determined:
a throttle demand;
a brake pedal is not depressed; and
brake pedal pressure is not sufficient to hold the vehicle stationary.

22. (canceled)
